(19) United States
(12) Patent Application Publication
(10) Pub. No.: US 2025/0011586 A1
(43) Pub. Date: Jan. 9, 2025

(54) MULTISTAGE IMPACT MODIFIERS WITH ORGANO-PHOSPHORUS IN A LATTER STAGE

(71) Applicant: Rohm and Haas Company, Collegeville, PA (US)

(72) Inventors: Pu Luo, King Of Prussia, PA (US); Morris Wills, Philadelphia, PA (US); William Rohrbach, Perkasie, PA (US); Mark A. Kesselmayer, Harleysville, PA (US)

(21) Appl. No.: 18/712,529

(22) PCT Filed: Dec. 7, 2022
(86) PCT No.: PCT/US2022/052070

§ 371 Date: May 22, 2024

Related U.S. Application Data
(63) Continuation of application No. 63/287,157, filed on Dec. 8, 2021.

(51) Int. Cl. C08L 9/00

(52) U.S. Cl. CPC C08L 9/00; C08L 2207/53; C08L 2314/00

(57) ABSTRACT

Provided are multistage polymer compositions comprising (a) an initial stage polymer, and (b) a latter stage polymer, wherein latter stage polymer comprises polymerized units derived from at least one alkyl (meth)acrylate monomer, a styrene monomer, and at least one organo-phosphorus monomer. The at least one organo-phosphorus monomer is in the acid form as a salt of the phosphorus acid group. The weight ratio of the at least one alkyl (meth)acrylate monomer to styrene monomer in the latter stage polymer ranges from 50:50 to 90:10. Also provided are matrix resin compositions comprising such polymer compositions and a matrix resin, and a method for making the multistage polymer compositions.

### FIELD OF THE INVENTION

This invention relates generally to multistage polymer compositions that are useful as impact modifiers. The compositions contain a polymerized organo-phosphorus monomer in a latter stage polymer.

### BACKGROUND

In the manufacture of products, there is the general desire to achieve ease of manufacture as well as lightweighting, i.e., reducing the weight of a product. Both of these objectives are achieved through the use of plastic, relative to the use of metal or ceramic. On the other hand, it is generally desirable for manufactured items to have low to no flammability which is provided by the use of metal or ceramic, but is generally not provided by the use of plastic.

Recently, plastic formulations have been developed with improved (i.e., lower) levels of flammability. In general, these formulations contain high levels of flame retardant additives in addition to anti-drip additives. These formulations have been able to achieve certain criteria as designated by UL (Underwriter Laboratories) that enable their use in the manufacture of electrical items as well as items for use under the hood of a car.

These plastic formulations generally have the requirement in use of substantial impact strength. However, the additives used to achieve lower flammability typically decrease the impact strength of the molded product. It is very common to add a core shell polymer impact modifier to these formulations to reach the required level of impact strength. However, the polymers used to make these core shell impact modifiers can be highly flammable and increase the flammability of the formulation in direct correlation to the amount utilized in the formulation. Thus, there exists a problem in the area of plastics formulation—achieving the proper balance of impact strength and flammability.

U.S. Pat. No. 5,219,907 discloses the use of a core shell emulsion polymer that contains a phosphate monomer as part of the shell, where the core shell polymer can be used in a polycarbonate formulation. The phosphate monomer requires halogen-free C₁-C₈ alkyl or halogen free unsubstituted or substituted C₆-C₂₀ aryl substituents on the phosphate group. The impact modifier must be employed at 5-40% in the polycarbonate formulation.

EP 0 663 410 discloses the use of a high concentration of phosphorus monomer located in the shell to provide improved flammability. The phosphorus monomer requires alkyl or aryl substituents on the phosphate group. The phosphorus monomer is present in an amount ranging from 15 to 25 wt % based on the total weight of the final polymer.

U.S. Pat. No. 6,710,161 discloses acrylic polymers prepared with phosphoethyl methacrylate (PEM). However, a pH of less than 2 is required to copolymerize the PEM with the acrylic polymers. It is suggested that at higher pH, the PEM is in the neutralized form which is too water soluble and ends up as homo-polyPEM in the serum phase, which can lead to coagulation or flocculation of the latex.

U.S. Pat. No. 9,346,970 discloses vinyl acetate polymers and copolymers with butyl acrylate that are prepared with PEM in conventional emulsion polymerization. Vinyl acetate hydrolyzes rapidly at low pH and cannot be polymerized according to the conditions required in U.S. Pat. No. 6,710,161. Vinyl acetate was successfully incorporated into the backbone polymer at a pH ranging from 5 to 7 without the production of homo-polyPEM in the serum. It is believed that the unique behavior of vinyl acetate is due to its high water solubility and very different vinyl copolymer reactivity ratios with butyl acrylate and PEM.

Accordingly, there is a need to develop new processes and impact modifier polymer compositions that do not suffer from the drawbacks of the prior art, namely, the use of alkyl or aryl substituted phosphate monomers or the use of highly acidic conditions.

### SUMMARY OF THE INVENTION

One aspect of the invention provides a multistage polymer composition comprising: (a) an initial stage polymer; and (b) a latter stage polymer. The latter stage polymer comprises polymerized units derived from at least one alkyl (meth)acrylate monomer, a styrene monomer, and at least one organo-phosphorus monomer. The at least one organo-phosphorus monomer is in the acid form or as a salt of the phosphorus acid groups.

In another aspect, the invention provides a matrix resin composition comprising: (A) a multistage polymer composition comprising (i) an initial stage polymer, and (ii) a latter stage polymer, and (B) one or more matrix resins. The latter stage polymer comprises polymerized units derived from at least one alkyl (meth)acrylate monomer, a styrene monomer, and at least one organo-phosphorus monomer. The at least one organo-phosphorus monomer is in the acid form or as a salt of the phosphorus acid groups.

In yet another aspect, the invention provides a process for preparing a multistage polymer composition comprising emulsion polymerizing a latter stage polymer in the presence of an initial stage polymer, wherein emulsion polymerizing the latter stage polymer comprises polymerizing a reaction mixture comprising at least one alkyl (meth)acrylate monomer, a styrene monomer, and at least one organo-phosphorus monomer at a pH of at least 4, wherein the at least one organo-phosphorus monomer is in the acid form or as a salt of the phosphorus acid groups.

### DETAILED DESCRIPTION

The inventors have surprisingly found that an organo-phosphorus monomer in an acid form or as a salt of the phosphorus acid groups can be incorporated into the latter stage of a multistage polymer at a higher pH than previously believed possible. This result is surprising because it is conventionally understood that highly acidic conditions are necessary to incorporate such a monomer. The inventors have observed that the multistage polymer composition of the invention has improved stability at higher pH conditions. The incorporation of the organo-phosphorus monomer is expected to provide significantly improved flammability.

As used herein, the term “polymer” refers to a polymeric compound prepared by polymerizing monomers, whether of the same or a different type. The generic term “polymer” includes the terms “homopolymer,” “copolymer,” “terpolymer,” and “resin.” As used herein, the term “polymerized units derived from” refers to polymer molecules that are synthesized according to polymerization techniques wherein a product polymer contains “polymerized units derived from” the constituent monomers which are the starting materials for the polymerization reactions. As used herein, the term “(meth)acrylate” refers to either acrylate or methacrylate or combinations thereof, and the term “(meth)acrylic” refers to either acrylic or methacrylic or combinations thereof. As used herein, the term “substituted” refers to having at least one attached chemical group, for example, alkyl group, alkenyl group, vinyl group, hydroxyl group, carboxylic acid group, other functional groups, and combinations thereof.

As used herein, the term “organo-phosphorus” refers to organic compounds containing phosphorus. As used herein, the term “phosphate” refers to an anion that is made up of phosphorous and oxygen atoms. Included are orthophosphate (PO₄⁻³), the polyphosphates (PₙO₃ₙ₊₁⁻⁽ⁿ⁺²⁾ where n is 2 or larger), and the metaphosphates (circular anions with the formula PₘO₃ₘ^{-m} where m is 2 or larger). As used herein, an “alkaline phosphate” refers to a salt of an alkali metal cation with a phosphate anion. Alkaline phosphates include alkali metal orthophosphates, alkali metal polyphosphates, and alkali metal metaphosphates. Alkaline phosphates also include partially neutralized salts of phosphate acids, including, for example, partially neutralized salts of orthophosphoric acid such as, for example, monosodium dihydrogen phosphate and disodium hydrogen phosphate.

As used herein, the term “multistage polymer” refers to a polymer that is made by forming (i.e., polymerizing) multiple polymers in steps or stages. The multistage polymer may comprise two or more stages. For example, the multistage polymer may comprise two stages, including a first stage and a second stage formed on the first stage. Alternatively, the multistage polymer may comprise a first stage, one or more intermediate stages, and then a final stage, where the final stage forms the outermost layer of the multistage polymer. A first polymer, called the “first stage polymer” or the “initial stage polymer,” may form a core of the multistage polymer. Then, in the presence of the initial stage polymer, an additional polymer called the “latter stage,” which can be an intermediate stage or the final stage of the multistage polymer, is formed on the initial stage polymer. The multistage polymer may comprise additional stages, which may be formed before or after the latter stage polymer. Each intermediate stage is formed in the presence of the polymer resulting from the polymerization of the stage immediately previous to that intermediate stage. In such embodiments wherein each subsequent stage forms a partial or complete shell around each of the particles remaining from the previous stage, the multistage polymer that results is known as a “core/shell” polymer, where the initial stage polymer comprises the core and each subsequent stage comprises a shell on the preceding stage with the final stage forming the outermost shell. Thus, the latter stage polymer will comprise at least part of the shell in a core/shell multistage polymer.

As used herein, the term “weight average molecular weight” or “M_{w}” refers to the weight average molecular weight of a polymer as measured by gel permeation chromatography (“GPC”), for acrylic polymers against polystyrene calibration standards following ASTM D5296-11 (2011), and using tetrahydrofuran (“THF”) as the mobile phase and diluent. As used herein, the term “weight of polymer” means the dry weight of the polymer.

As used herein, the terms “glass transition temperature” or “T_{g}” refers to the temperature at or above which a glassy polymer will undergo segmental motion of the polymer chain. Glass transition temperatures of a copolymer can be estimated by the Fox equation (Bulletin of the American Physical Society, 1 (3) Page 123 (1956)) as follows:

$$1 / {T}_{g} = {w}_{1} / {T}_{g ( 1 )} + {w}_{2} / {T}_{g ( 2 )}$$

For a copolymer, w₁ and w₂ refer to the weight fraction of the two comonomers, and T_{g(1)} and T_{g(2)} refer to the glass transition temperatures of the two corresponding homopolymers made from the monomers. For polymers containing three or more monomers, additional terms are added (wₙ/T_{g(n)}). The glass transition temperatures of the homopolymers may be found, for example, in the “Polymer Handbook,” edited by J. Brandrup and E. H. Immergut, Interscience Publishers. The T_{g} of a polymer can also be measured by various techniques, including, for example, differential scanning calorimetry (“DSC”). As used herein, the phrase “calculated T_{g}” shall mean the glass transition temperature as calculated by the Fox equation. When the T_{g} of a multistage polymer is measured, more than one T_{g} may be observed. The T_{g} observed for one stage of a multistage polymer may be the same as the T_{g} that is characteristic of the polymer that forms that stage (i.e., the T_{g} that would be observed if the polymer that forms that stage were formed and measured in isolation from the other stages). When a monomer is said to have a certain T_{g}, it is meant that a homopolymer made from that monomer has that T_{g}.

A compound is considered “water-soluble” herein if the amount of that compound that can be dissolved in water at 20° C. is 5 g or more of compound per 100 ml of water. A compound is considered “water-insoluble” herein if the amount of that compound that can be dissolved in water at 20° C. is 0.5 g or less of compound per 100 ml of water. If the amount of a compound that can be dissolved in water at 20° C. is between 0.5 g and 5 g per 100 ml of water, that compound is said herein to be “partially water-soluble.”

As used herein, when it is stated that “the polymer composition contains little or no” of a certain substance, it is meant that the polymer composition contains none of that substance, or, if any of that substance is present in the present composition, the amount of that substance is 1% or less by weight, based on the weight of the polymer composition. Among embodiments that are described herein as having “little or no” of a certain substance, embodiments are envisioned in which there is none of that certain substance.

The multistage polymer of the present invention contains a latter stage polymer containing polymerized units derived from at least one organo-phosphorus monomer. As used herein, the term “organo-phosphorus monomer” refers to a phosphorus-containing monomer. The organo-phosphorus monomer may be in the acid form or as a salt of the phosphorus acid groups. Examples of organo-phosphorus monomers include:

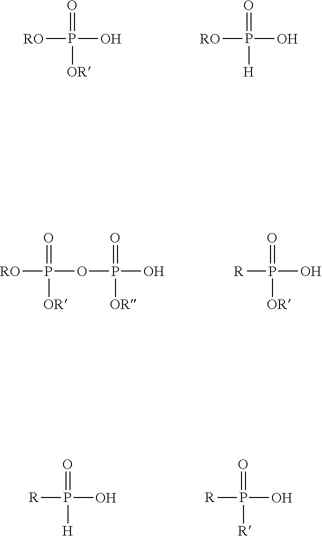

where R is an organic group containing an acryloxy, methacryloxy, or a vinyl group, and R′ and R″ are independently selected from H and a second organic group. The second organic group may be saturated or unsaturated. Suitable organo-phosphorus monomers include dihydrogen phosphate-functional monomers such as dihydrogen phosphate esters of an alcohol in which the alcohol also contains a polymerizable vinyl or olefinic group, such as allyl phosphate, mono- or diphosphate of bis(hydroxy-methyl) fumarate or itaconate, derivatives of (meth)acrylic acid esters, such as, for examples phosphates of hydroxyalkyl(meth)acrylates including 2-hydroxyethyl (meth)acrylate, 3-hydroxypropyl (meth)acrylates, and the like.

Other suitable organo-phosphorous monomers include CH₂═C(R)—C(O)—O—(R′O)ₙ—P(O)(OH)₂, where R═H or —CH₃, R′=alkyl, and n=1 to 5, such as the methacrylates SIPOMER™ PAM-100, SIPOMER™ PAM-200, SIPOMER™ PAM-400, SIPOMER™ PAM-600 and the acrylate, SIPOMER™ PAM-300, available from Solvay.

Other suitable organo-phosphorus monomers are phosphonate functional monomers, disclosed in WO 99/25780 A1, and include vinyl phosphonic acid, allyl phosphonic acid, 2-acrylamido-2-methylpropanephosphonic acid, α-phosphonostyrene, 2-methylacrylamido-2-methylpropanephosphonic acid. Further suitable organo-phosphorus monomers are 1,2-ethylenically unsaturated (hydroxy)phosphinylalkyl (meth)acrylate monomers, disclosed in U.S. Pat. No. 4,733,005, and include (hydroxy)phosphinylmethyl methacrylate.

Preferably, the organo-phosphorus monomers comprise at least one compound of formula CH₂=C(R)—C(O)—O—(R′O)ₙ—P(O)(OH)₂. More preferably, R is —CH₃, R′ is an alkyl group comprising 1 to 6 carbon atoms, and n=1.

The latter stage polymer may contain polymerized units derived from the at least one organo-phosphorus monomer in an amount of 0.25 weight % or more, or 0.5 weight % or more, based on the total weight of the latter stage polymer. The latter stage polymer may contain polymerized units derived from the at least one organo-phosphorus monomer in an amount of 20 weight % or less, 15 weight % or less, or 10 weight % or less, based on the total weight of the latter stage polymer. Preferably, the latter stage polymer contains polymerized units derived from the at least one organo-phosphorus monomer in an amount ranging from 0.5 to 20 weight % based on total weight of the latter stage polymer. More preferably, the latter stage contains polymerized units derived from the at least one organo-phosphorus monomer in an amount ranging from 2 to 10 weight % based on the total weight of the latter stage polymer.

The latter stage polymer further comprises polymerized units derived from one or more substituted or unsubstituted styrene and one or more substituted or unsubstituted alkyl (meth)acrylate monomers.

Suitable alkyl groups in the at least one alkyl (meth)acrylate monomers include straight or branched C₁ to C₁₂ alkyl groups. Preferred alkyl groups include methyl, ethyl, propyl, butyl, hexyl, 2-ethylhexyl, and octyl groups. Preferably, the alkyl (meth)acrylate monomers comprise methyl methacrylate.

Suitable substituted styrenes include, for example, alpha-alkyl styrenes (e.g., alpha-methyl styrene).

Preferably, the weight ratio of the at least one alkyl (meth)acrylate to styrene in the latter stage polymer ranges from 5:95 to 95:5. For example, the weight ratio of the at least one alkyl (meth)acrylate to styrene in the latter stage polymer may be at least 10:90, at least 20:80, at least 30:70, at least 40:60, or at least 50:50, and the weight ratio of the at least one alkyl (meth)acrylate to styrene in the latter stage polymer may be at most 90:10, at most 80:20, or at most 70:30.

The latter stage polymer may have a T_{g} of 50° C. or more, or 90° C. or more. The latter stage polymer may have a T_{g} of 200° C. or less, or 150° C. or less.

The multistage polymer may contain the latter stage polymer, for example, in an amount of 2 weight % or more, or 10 weight % or more, or 20 weight % or more, based on the total weight of the multistage polymer. The multistage polymer may contain the latter stage polymer, for example, in an amount of 50 weight % or less, or 25 weight % or less, or 10 weight % or less, based on the total weight of the multistage polymer.

Preferably, the latter stage polymer contains polymerized units derived from monomers having a T_{g} of 50° C. or higher in an amount of 50 wt % or higher, or 75 wt % or higher, or 90 wt % or higher based on the total weight of the latter stage polymer.

Preferably, the latter stage polymer is the final stage polymer of the multistage polymer.

The multistage polymer may contain the initial stage polymer, for example, in an amount of 10 wt % or more, or 20 wt % or more, or 50 wt % or more, based on the total weight of the multistage polymer. The multistage polymer may contain the initial stage polymer in an amount of 98 wt % or less, or 95 wt % or less, or 90 wt % or less, based on the total weight of the multistage polymer.

The initial stage of the multistage polymer may contain polymerized units derived from one or more multifunctional monomers. Multifunctional monomers contain two or more functional groups that are capable of participating in a polymerization reaction. Suitable multifunctional monomers include, for example, divinylbenzene, allyl methacrylate, ethylene glycol methacrylate, and 1,3-butylene dimethacrylate. When present, the initial stage may contain polymerized units derived from a multifunctional monomer in an amount of 0.01 weight % or more, or 0.03 weight % or more, or 0.1 weight % or more, based on the weight of the total weight of the initial stage polymer. When present, the initial stage may contain polymerized units derived from a multifunctional monomer in an amount of 5 weight % or less, or 2 weight % or less, based on the weight of the total weight of the initial stage polymer.

The initial stage of the multistage polymer may contain polymerized units derived from one or more diene monomers. Suitable diene monomers include, for example, butadiene and isoprene. The initial stage may contain polymerized units derived from diene monomers in an amount of 2 weight % or more, or 5 weight % or more, or 10 weight % or more, or 20 weight % or more, or 50 weight % or more, or 75 weight % or more, based on the total weight of the initial stage polymer. The initial stage contains polymerized units derived from diene monomers in an amount of 100 weight % or less, or 98 weight % or less, or 90 weight % or less, based on the total weight of the initial stage polymer.

The initial stage polymer of the multistage polymer may contain polymerized units derived from one or more of styrene, substituted styrene, or mixtures thereof. The initial stage polymer may contain polymerized units derived from one or more of styrene and substituted styrene in an amount of 1 weight % or more, or 2 weight % or more, or 5 weight % or more, or 10 weight % or more, based on the total weight of the initial stage polymer. The initial stage polymer may contain polymerized units derived from one or more of styrene and substituted styrene in an amount of 80 weight % or less, or 50 weight % or less, or 25 weight % or less, or 10 weight % or less, or 5 weight % or less, based on the total weight of the initial stage polymer.

The initial stage polymer of the multistage polymer may contain polymerized units derived from acid-functional monomers. An acid-functional monomer is a monomer that has an acid group, for example, a sulfonic acid group or a carboxylic acid group. Suitable acid-functional monomers include, for example, acrylic acid and methacrylic acid. The initial stage polymer may contain polymerized units derived from one or more acid functional monomers in an amount of 3 weight % or less, or 2 weight % or less, or 1 weight % or less, or 0.5 weight % or less, based on the total weight of the initial stage polymer.

The initial stage polymer of the multistage polymer may further comprise polymerized units derived from a phosphor-organic as described above for the latter stage polymer. Without wishing to be bound by theory, it is believed that incorporating an organo-phosphorus monomer in both the initial stage polymer and the latter stage polymer may further improve flammability.

When present, the initial stage polymer may contain polymerized units derived from the at least one organo-phosphorus monomer in an amount of 0.25 weight % or more, or 0.5 weight % or more, based on the total weight of the initial stage polymer. The initial stage polymer may contain polymerized units derived from the at least one organo-phosphorus monomer in an amount of 5 weight % or less, 4 weight % or less, 3 weight % or less, 2 weight % or less, or 1 weight % or less, based on the total weight of the initial stage polymer.

Preferably, the initial stage polymer comprises butadiene, more preferably crosslinked butadiene.

The weight ratio of the initial stage polymer to the latter stage polymer may range, for example, from 0.1:1 or higher, or 0.2:1 or higher, or 0.4:1 or higher, or 1:1 or higher, or 1.5:1 or higher, or 3:1 or higher, or 4:1 or higher. The weight ratio of the initial stage polymer to the latter stage polymer may range, for example, from 50:1 or lower, or 25:1 or lower, or 20:1 or lower.

The multistage polymer may contain one or more intermediate stage polymers. The total sum of the intermediate stage polymers may be present in an amount of 1 weight % or more, or 2 weight % or more, or 5 weight % or more, or 10 weight % or more, based on the total weight of the multistage polymer. The total sum of the intermediate stage polymers may be present in an amount of 60 weight % or less, or 2 weight % or less, or 5 weight % or less, or 10 weight % or less, based on the total weight of the multistage polymer. Like the latter stage polymer in the multistage polymer, the one or more intermediate stage polymers may also comprise polymerized units derived from one or more organo-phosphorus monomers.

The multistage polymer is made by aqueous emulsion polymerization. In aqueous emulsion polymerization, water forms the continuous medium in which polymerization takes place. The water may or may not be mixed with one or more additional compounds that are miscible with water or that are dissolved in the water. The continuous medium may contain 30 weight % or more water, or 50 weight % or more water, or 75 weight % or more water, or 90 weight % or more water, based on the weight of the continuous medium.

Emulsion polymerization involves the presence of one or more initiator. An initiator is a compound that forms one or more free radical, which can initiate a polymerization process. The initiator is usually water-soluble. Some suitable initiators form one or more free radical when heated. Some suitable initiators are oxidants and form one or more free radical when mixed with one or more reductant, or when heated, or a combination thereof. Some suitable initiators form one or more free radical when exposed to radiation such as, for example, ultraviolet radiation or electron beam radiation. A combination of suitable initiators is also suitable.

Preferably, the multistage polymer is made by emulsion polymerization to form a latex. As used herein, the term “latex” refers to the physical form of a polymer in which the polymer is present in the form of small polymer particles that are dispersed in water. The latex may have, for example, a mean particle size of 50 nm or greater or 100 nm or greater. The latex may have a mean particle size of 1,000 nm or less, or 800 nm or less, or 600 nm or less.

The emulsion polymerization may involve the use of at least one organo-phosphorus soap comprising an anionic phosphate surfactant. Each anionic phosphate surfactant has a cation associated with it forming an alkaline metal salt of the phosphate surfactant including, for example, alkyl phosphate salts and alkyl aryl phosphate salts. Suitable cations include, for example, ammonium, cation of an alkali metal, and mixtures thereof. Suitable alkaline metal salts of the phosphate surfactant include, for example, polyoxyalkylene alkyl phenyl ether phosphate salt, polyoxyalkylene alkyl ether phosphate salt, polyoxyethylene alkyl phenyl ether phosphate salt, and polyoxyethylene alkyl ether phosphate salt. The alkaline metal salt of the phosphate surfactant may comprise a polyoxyethylene alkyl ether phosphate salt. The weight of the phosphate surfactant present in emulsion polymerization of the multistage polymer may range from, for example, 0.5 wt % or more, preferably 1.0 wt % or more, and more preferably 1.5 wt % or more, as characterized by weight of phosphate surfactant based on the total monomer weight added to the polymerization. The weight of the phosphate surfactant present in emulsion polymerization of the multistage polymer may range from, for example, 5 wt % or less, preferably 4 wt % or less, and more preferably 3 wt % or less, as characterized by weight of phosphate surfactant based on the total monomer weight added to the polymerization. One or more anionic surfactants in addition to the anionic phosphate surfactant described above may be utilized in the emulsion polymerization. Suitable additional anionic surfactants include, for example, carboxylates, sulfosuccinates, sulfonates, and sulfates.

In the process of the present invention, the multistage polymer latex can isolated by coagulation or spray drying to retain the organo-phosphorus soap on the surface of the multistage polymer. Suitable methods of coagulation include, for example, coagulation with a divalent cation.

Suitable divalent cations include, for example, divalent metal cations and alkaline earth cations. Suitable divalent cations include, for example, calcium (+2), cobalt (+2), copper (+2), iron (+2), magnesium (+2), zinc (+2), and mixtures thereof. Preferably, the multivalent cations are selected from calcium (+2), and magnesium (+2). More preferably, every divalent cation that is present is calcium (+2), or magnesium (+2), or a mixture thereof. Even more preferably, the divalent cation comprises calcium (+2). The divalent cation may be present, for example, in an amount of 10 ppm or more, or 30 ppm or more, or 100 ppm or more, by weight based on the dry weight of multistage polymer. The divalent cation may be present, for example, in an amount of 3 weight % or less, or 1 weight % or less, or 0.3 weight % or less, based on the dry weight of the multistage polymer.

Preferably, most or all of the divalent cation that is present in the composition is in the form of a water insoluble phosphate salt. The molar amount of divalent cation that is present in the form of a water insoluble phosphate salt may be, for example, 80% or more, or 90% or more, or 95% or more, or 98% or more, or 100%, based on the total moles of divalent cation present in the composition.

Preferably, most or all of the water that remains with the isolated polymer is removed from the isolated polymer by one or more of the following operations: filtration (including, for example, vacuum filtration), and/or centrifugation. The isolated polymer maybe optionally washed with water one or more times. Coagulated polymer is a complex structure, and it is known that water cannot readily contact every portion of the coagulated polymer. While not wishing to be bound by theory, it is contemplated that a significant amount of divalent cation and residual organo-phosphorus soap will be left behind. Accordingly, the composition of the present invention may contain organo-phosphorus soap in an amount of 50 ppm or more, or 100 ppm or more, or 500 ppm or more, based on the dry weight of the multistage polymer. The composition of the present invention may contain organo-phosphorus soap in an amount of 10,000 ppm or less, or 7,500 ppm or less, or 5,000 ppm or less, based on the dry weight of the multistage polymer.

Preferably, the dried multistage polymer has a water content of less than 1.0 weight % based on the weight of the dried multistage polymer.

The polymer composition of the present invention may also include a flow aid. A flow aid is a hard material in the form of a powder (mean particle diameter of 1 micrometer to 1 mm). Suitable flow aids include, for example, hard polymers (i.e., polymers having a T_{g} of 80° C. or higher) or a mineral (e.g., silica).

The polymer composition of the present invention may also include a stabilizer. Suitable stabilizers include, for example, radical scavengers, peroxide decomposers, and metal deactivators. Suitable radical scavengers include, for example, hindered phenols (e.g., those having a tertiary butyl group attached to each carbon atom of the aromatic ring that is adjacent to the carbon atom to which a hydroxyl group is attached), secondary aromatic amines, hindered amines, hydroxylamines, and benzofuranones. Suitable peroxide decomposers include, for example, organic sulfides (e.g., divalent sulfur compounds, e.g., esters of thiodopropionic acid), esters of phosphorous acid (H₃PO₃), and hydroxyl amines. Suitable metal deactivators include, for example, chelating agents (e.g., ethylenediaminetetraacetic acid).

As noted above, one aspect of the present invention utilizes the polymer composition described herein as an impact modifier in a matrix resin composition containing the multistage polymer composition and a matrix resin. After the mixture of multistage polymer and matrix resin is mixed and melted and formed into a solid item, the impact resistance of that item will be better than the same solid item made with matrix resin that has not been mixed with multistage polymer. The multistage polymer may be provided in a solid form, e.g., pellets or powder or a mixture thereof. The matrix resin may also be provided in solid form, e.g., pellets or powder or a mixture thereof. Solid multistage polymer may be mixed with solid matrix resin, either at room temperature (20° C.) or at elevated temperature (e.g., 30° C. to 90° C.). Alternatively, solid multistage polymer may be mixed with melted matrix resin, e.g., in an extruder or other melt mixer. Solid multistage polymer may also be mixed with solid matrix resin, and the mixture of solids may then heated sufficiently to melt the matrix resin, and the mixture may be further mixed, e.g., in an extruder or other melt-processing device.

The weight ratio of the matrix resin to the multistage polymer of the present invention may range for example, from 1:1 or higher, or 1.1:1 or higher, or 2.3:1 or higher, or 4:1 or higher, or 9:1 or higher, or 19:1 or higher, or 49:1 or higher, or 99:1 or higher.

Suitable matrix resins include, for example, polyolefins, polystyrene, styrene copolymers, poly(vinyl chloride), poly(vinyl acetate), acrylic polymers, polyethers, polyesters, polycarbonates, polyurethanes, and polyamides. Preferably, the matrix resin contains at least one polycarbonate. Suitable polycarbonates include, for example homopolymers of polymerized units derived from Bisphenol A (“BPA”), and also copolymers that include polymerized units of BPA along with one or more other polymerized units.

The matrix resin may contain at least one polyester. Suitable polyesters include, for example, polyethylene terephthalate and polybutylene terephthalate.

The matrix resin may contain a blend of polymers. Suitable blends of polymers include, for example, blends of polycarbonates and styrene resins, and blends of polycarbonates and polyesters. Suitable styrene resins include, for example, polystyrene and copolymers of styrene with other monomers, e.g., acrylonitrile/butadiene/styrene (“ABS”) resins.

The matrix resin composition containing multistage polymer and matrix resin may contain one or more additional materials that are added to the mixture. Any one or more of such additional materials may be added to the multistage polymer or to the matrix resin prior to formation of the final mixture of all materials. Each of the additional materials (if any are used) may be added (alone or in combination with each other and/or in combination with multistage polymer) to matrix resin when matrix resin is in solid form or in melt form. Suitable additional materials include, for example, dyes, colorants, pigments, carbon black, fillers, fibers, lubricants (e.g., montan wax), flame retardants (e.g., borates, antimony trioxide, or molybdates), and other impact modifiers that are not multistage polymers of the present invention.

The matrix resin composition may be used to form a useful article, for example by film blowing, profile extrusion, molding, other methods, or a combination thereof. Molding methods include, for example, blow molding, injection molding, compression molding, other molding methods, and combinations thereof.

The multistage polymer of the present invention may provide significant improvements in the flammability of the matrix resin composition.

Some embodiments of the invention will now be described in detail in the following Examples.

### EXAMPLES

### Particle Size Measurement

The particle size of the oligomers were measured on a Malvern Zetasizer Nano S90 particle size analyzer.

### Core Shell Polymer Synthesis

### Preparation of Polybutadiene Initial Stage Emulsion

A stainless-steel autoclave with an agitator and several entry ports was charged 6300 parts of deionized water, 170 parts of a 60 nm polymer preform and 4 parts of potassium oleate. After evacuating the reactor, 3200 parts of butadiene, 4 parts of divinylbenzene, 37 parts of diisopropylbenzene hydroperoxide, 11 parts of sodium formaldehyde sulfoxylate and 30 additional parts of potassium oleate were added and the mixture was allowed to react at 65° C. until there was no longer a drop in pressure. The reaction vessel was then vented to remove any remaining volatile material. The final emulsion had a solid content of 32%.

### Preparation of Core Shell Polymer Emulsion EX1

To 1000 parts of the polybutadiene emulsion having 32% solids, as prepared above, were added 144 part of deionized water, and the mixture was heated to 60° C. At 60° C. 2.1 part of Rhodafac® RS-610, 2.41 parts of sodium formaldehyde sulfoxylate (5% aqueous solution) and 1.69 parts of tert-butyl hydroperoxide (5% aqueous solution), followed a monomer mixture of 84 parts of methyl methacrylate, 31.2 parts of styrene, 4.3 parts of PAM600 over 1 hour. At the same time the monomer mixture feed began, 12 parts of sodium formaldehyde sulfoxylate (5% aqueous solution) and 8.45 parts of tert-butyl hydroperoxide (5% aqueous solution) were fed in over 240 min, while maintaining the reaction temperature at 60° C. After all feeds were completed, 11.29 part of Rhodafac® RS-610 were added. The reaction mixture was then cooled to room temperature and measured to have solid content of 33.6%.

### Coagulation Procedure of Polymer Emulsion

### Antioxidant Emulsion Preparation

To a 100 ml plastic container were added 6.3 g potassium oleate, 3.4 g BNX® DLTDP, 3.4 g butylated hydroxytoluene, 0.8 g Irganox 245, and 23.3 g deionized water. The mixture was heated to 60° C. and homogenized at 10,000 rpm for 10 minutes.

### Emulsion Coagulation Preparation

To a 1 Liter bottle was added 804 g of emulsion and diluted with 96 g of Deionized water. This mixture was heated to 58° C. in a water bath. Once emulsion was at >50° C. 31.7 g of the antioxidant emulsion listed above was added and mixed thoroughly. The emulsion was stored at 58° C. until ready for Coagulation.

### Coagulation

To a 4 liter beaker were added 3.6 g of Calcium Chloride powder and 1796.4 g deionized water. The beaker content was heated to 58° C. under agitation at 350 rpm. When the content reached 58° C., the preheated emulsion above was added slowly over 45-60 seconds to the beaker. This caused phase separation of the mixture into a water phase and a solid polymer phase. 72 g of a 10% Calcium Chloride aqueous solution was added to complete the coagulation. The mixture was then heated to 90° C. and held at 90° C. for 30 minutes. After the hold, the mixture was cooled, dewatered, and washed in a Büchner funnel. The samples were washed with deionized water until the filtrate conductivity is below 30 μS/m, and then dewatered. The samples were dried in a vacuum oven for overnight at 65° C. The particle size of the powder was measured on a Malvern Mastersizer 2000.

### Formulation

Polycarbonate formulations in accordance with Table 1 were compounded in an extruder to create pellets for injection molding.

TABLE 1

| Material | Loading level |
|---|---|
| LEXAN 141 | Add to 100% |
| MBS | 2.50% |
| FR-2025a | 0.10% |
| INP449 | 0.50% |
| Irg 1076 | 0.10% |
| Irg 168 | 0.10% |

PC Lexan 141: Polycarbonate from SABIC
MBS: FR MBS powder of the inventive examples or M732 powder of Comparative Example
FR-2025a: 100% potassium perfluorobutane sulfonate from 3M
INP449: blend of 50% polytetrafluoroethylene and 50% SAN from SABIC
IRGANOX® 1076 and IRGANOX® 168: anti-oxidants from BASF

The polycarbonate formulations were injection molded to form double end-gated 1.0 mm ASTM burn bars for flammability testing using the UL 94 flammability test method.

### COMPARATIVE EXAMPLES

Methyl butadiene styrene (MBS) core shell rubber impact modifiers were prepared by in accordance with the process described above with the exception that the composition of the MBS impact modifiers had the formulation shown in Table 2. The results for the comparative examples are shown below in Table 2. As seen in Table 2, both Comparative Examples CE1 and CE2 coagulated during the polymerization of the latter stage (shell). It was believed that the phosphoethyl methacrylate homo-polymerized in the serum in accordance with the teachings of U.S. Pat. No. 6,710,161. This result was consistent with the severe colloidal stability issues observed in the art when polymerization of phosphoethyl methacrylate is carried out at neutral to high pH.

TABLE 2

| | | Shell Composition | | | | PAM | | |
|---|---|---|---|---|---|---|---|---|
| | Core// | | | | PAM | 600 | Final Latex | |
| Example | Shell | MMA | Sty | DVB | 600 | BOTP | Solids | Gel |

| | | | | | | | |
|---|---|---|---|---|---|---|---|
| CE1 | 77//23 | 96.3% | 2.0% | 1.7% | 0.5% | 0.12% | Too much gel |
| | | | | | | | for sample |
| CE2 | 77//23 | 96.3% | 2.0% | 1.7% | 1.0% | 0.23% | Too much gel |
| | | | | | | | for sample |

### INVENTIVE EXAMPLES

Methyl butadiene styrene (MBS) core shell rubber impact modifiers were prepared in accordance with the process described above, where the compositions of the inventive examples is shown below in Table 3. As shown in Table 3, the inventive examples exhibited excellent stability at high pH conditions and were able to incorporated the phosphoethyl methacrylate successfully in the latter stage (shell) polymer. The inventive examples also exhibited excellent flame resistance when tested under the UL-94 flammability test.

TABLE 3

| | | Shell Composition | | | Final | |
|---|---|---|---|---|---|---|
| | Core// | | | PAM | Latex | FR test |
| Example | Shell | MMA | Styrene | 600 | Solids | UL-94 |
| Ex. 1 | 73//27 | 71.5% | 26.5% | 2.0% | 33.6% | V-0 |
| Ex. 2 | 73//27 | 70.8% | 26.2% | 3.0% | 34.0% | Not tested |
| Ex. 3 | 73//27 | 69.4% | 25.7% | 5.0% | 33.8% | V-0 |
| Ex. 4 | 73//27 | 65.7% | 24.3% | 10.0% | 32.1% | V-0 |
| Control | 73//27 | 70.0% | 30.0% | 0.0% | 35.5% | V-1/V-1 |
| Ex. 5 | 73//27 | 67.5% | 27.5% | 5.0% | 34.9% | V-0 |
| Ex. 6 | 73//27 | 65.0% | 25.0% | 10.0% | 34.6% | NR/V-1 |
| Ex. 7 | 80//20 | 65.0% | 25.0% | 10.0% | 34.0% | V-0 |

1. A multistage polymer composition comprising:
(a) an initial stage polymer; and
(b) a latter stage polymer, wherein the latter stage polymer comprises polymerized units derived from at least one alkyl (meth)acrylate monomer, a styrene monomer, and at least one organo-phosphorus monomer, wherein the at least one organo-phosphorus monomer is in the acid form or as a salt of the phosphorus acid groups, and wherein the weight ratio of the at least one alkyl (meth)acrylate monomer to styrene monomer in the latter stage polymer ranges from 5:95 to 95:5.

2. The polymer composition of claim 1, wherein the weight ratio of the at least one alkyl (meth)acrylate monomer to styrene monomer in the latter stage polymer ranges from 10:90 to 90:10.

3. The polymer composition of claim 1, wherein the organo-phosphorus monomer is a compound of formula, CH₂═C(R)—C(O)—O—(R′O)ₙ—P(O)(OH)₂, where R═H or —CH₃, R′=alkyl, and n=1 to 5.

4. The polymer composition of claim 3, wherein R is —CH₃ and R′ is an alkyl group comprising 1 to 6 carbon atoms.

5. The polymer composition of claim 1, wherein the organo-phosphorus monomer is present in the latter stage polymer in an amount ranging from 0.5 to 20 wt % relative to the total weight of the latter stage polymer.

6. The polymer composition of claim 5, wherein the organo-phosphorus monomer is present in the latter stage polymer in an amount ranging from 2 to 10 wt % relative to the total weight of the latter stage polymer.

7. The polymer composition of claim 1, wherein the at least one alkyl (meth)acrylate monomer comprises methyl methacrylate.

8. The polymer composition of any one of the preceding claims, wherein the initial stage polymer comprises polymerized units derived from butadiene.

9. The polymer composition of claim 1, wherein the initial stage polymer comprises polymerized units derived from at least one organo-phosphorus monomer, wherein the at least one organo-phosphorus monomer in the initial stage polymer is the same or different from the at least one organo-phosphorus monomer in the latter stage polymer.

10. The polymer composition of claim 1, wherein the initial stage polymer is present in an amount of from 10 to 98 weight %, based on the total weight of the multistage polymer, and the latter stage polymer is present in an amount of from 2 to 50 weight %, based on the total weight of the multistage polymer.

11. A matrix resin composition comprising mixing one or more matrix resins and the multistage polymer composition of claim 1.

12. A process for preparing a multistage polymer composition comprising emulsion polymerizing a latter stage polymer in the presence of an initial stage polymer, wherein emulsion polymerizing the latter stage polymer comprises polymerizing a reaction mixture comprising at least one alkyl (meth)acrylate monomer, a styrene monomer, and at least one organo-phosphorus monomer at a pH of at least 4, wherein the at least one organo-phosphorus monomer is in the acid form or as a salt of the phosphorus acid groups.

13. The process of claim 12, wherein the organo-phosphorus monomer is a compound of formula, CH₂═C(R)—C(O)—O—(R′O)ₙ—P(O)(OH)₂, where R═H or —CH₃, R′=alkyl, and n=1 to 5.

14. The process of claim 13, wherein R is —CH₃ and R′ is an alkyl group comprising 1 to 6 carbon atoms.
